(19) United States
(12) Patent Application Publication
(10) Pub. No.: US 2023/0374954 A1
(43) Pub. Date: Nov. 23, 2023

(54) GAS FUEL FILLING AND SUPPLYING SYSTEM

(71) Applicant: ISUZU MOTORS LIMITED, Tokyo (JP)

(72) Inventor: Sota TAKANO, Fujisawa-shi, Kanagawa (JP)

(21) Appl. No.: 18/044,609

(22) PCT Filed: Sep. 16, 2021
(86) PCT No.: PCT/JP2021/034108

§ 371 Date: Mar. 9, 2023

(30) Foreign Application Priority Data
Sep. 28, 2020 (JP) 2020-161671

(51) Int. Cl. F02M 21/02; B67D 7/52

(52) U.S. Cl. CPC F02M 21/023; B67D 7/52; F16K 31/0655

(57) ABSTRACT

A gas fuel filling and supplying system includes: a tank; a filling pipe having a filling port; a supplying pipe; a branch pipe that branches from a connection part between the filling pipe and the supplying pipe and is connected to the tank; a normally closed solenoid value provided in the branch pipe; and a control part that controls opening and closing of the solenoid valve, wherein the control part controls the solenoid valve to be in an open state while a gas engine is driven, controls the solenoid valve to be in a closed state while the gas engine is stopped, and controls the solenoid valve to be in an open state during filling of the tank with gas fuel from the filling port.

### TECHNICAL FIELD

The present disclosure relates to a gas fuel filling and supplying system, and more particularly, to technology suitable for a fuel filling and supplying system of a gas engine.

### BACKGROUND OF THE INVENTION

Conventionally, a vehicle equipped with a gas engine using compressed natural gas (hereinafter referred to as CNG) as a fuel has been put into practical use. A fuel filling and supplying system of this type of gas engine is disclosed in Patent Document 1, for example.

### PRIOR ART

### Patent Literature

Patent Document 1: Japanese Patent No. 3407445

### BRIEF DESCRIPTION OF THE INVENTION

### Problem to be Solved by the Invention

The above-mentioned fuel filling and supplying system includes a fuel tank that stores CNG. A filling pipe through which CNG flows from a filling port into which a nozzle is inserted when fuel is filled and a supplying pipe through which CNG flows at the time of supplying CNG to the engine are connected to the fuel tank. The downstream end of the filling pipe and the upstream end of the supplying pipe are joined to each other, and are connected to the fuel tank as a single pipe (hereinafter, a branch pipe).

The branch pipe may be provided with a solenoid valve serving as a main stop valve which is turned on when the engine is running and turned off when the engine is stopped or when fuel is filled. Since CNG pushes open and passes through a valve element of the solenoid valve while the fuel is being filled, vibration occurs in the solenoid valve, and such vibration affects noise, durability of the pipe, and the like.

The present disclosure focuses on these points, and its object is to effectively prevent the occurrence of vibration in a solenoid valve when fuel is filled.

### Means for Solving the Problem

According to an embodiment of the present disclosure, there is provided a technology including: a tank that stores gas fuel; a filling pipe provided with a filling port for the gas fuel at an upstream end; a supplying pipe having an upstream end connected to a downstream end of the filling pipe and a downstream end connected to an injector facing an intake passage of a gas engine; a branch pipe that branches from a connection part between the filling pipe and the supplying pipe and is connected to the tank; a normally closed solenoid valve provided in the branch pipe; and a control part that controls opening and closing of the solenoid valve, wherein the control part controls the solenoid valve to be in an open state while the gas engine is driven, controls the solenoid valve to be in a closed state while the gas engine is stopped, and controls the solenoid valve to be in an open state during filling of the tank with the gas fuel from the filling port.

It is preferable that the technology further includes a detection means that detects insertion of the fuel nozzle into the filling port and removal of the fuel nozzle from the filling port, wherein the control part may control the solenoid valve to be in an open state when the detection means detects the insertion of the fuel nozzle, and control the solenoid valve to be in a closed state when the detection means detects the removal of the fuel nozzle.

Preferably, the technology further includes an engine switch that transmits a signal indicating running or stoppage of the gas engine to the control part; and a battery, wherein the solenoid valve may include an electromagnetic coil, and the control part may control the solenoid valve to be in an open state by supplying a current from the battery to the electromagnetic coil when the detection means detects the insertion of the fuel nozzle while receiving a signal indicating stoppage of the gas engine from the engine switch.

Further, it is preferable that the control part may determine whether the detection means has detected the removal of the fuel nozzle while controlling the electromagnetic coil to be energized and the solenoid valve to be in the open state due to the detection means detecting the insertion of the fuel nozzle.

### Effect of the Invention

According to the technology of the present disclosure, it is possible to effectively prevent the occurrence of vibration in the solenoid valve when fuel is filled.

### BRIEF DESCRIPTION OF THE DRAWINGS

FIG. 1 is a schematic overall configuration diagram showing an engine and a gas fuel filling and supplying system according to the present embodiment.

FIG. 2 is a schematic cross-sectional view showing a solenoid valve according to the present embodiment.

FIG. 3 is a schematic diagram showing a controller according to the present embodiment and related peripheral configurations.

FIG. 4 is a diagram illustrating a control process according to the present embodiment.

### DESCRIPTION OF EMBODIMENTS

Hereinafter, a gas fuel filling and supplying system according to the present embodiment will be described with reference to the attached drawings. The same components are denoted by the same reference numerals, and their names and functions are also the same. Therefore, detailed description thereof will not be repeated.

### [Overall Configuration]

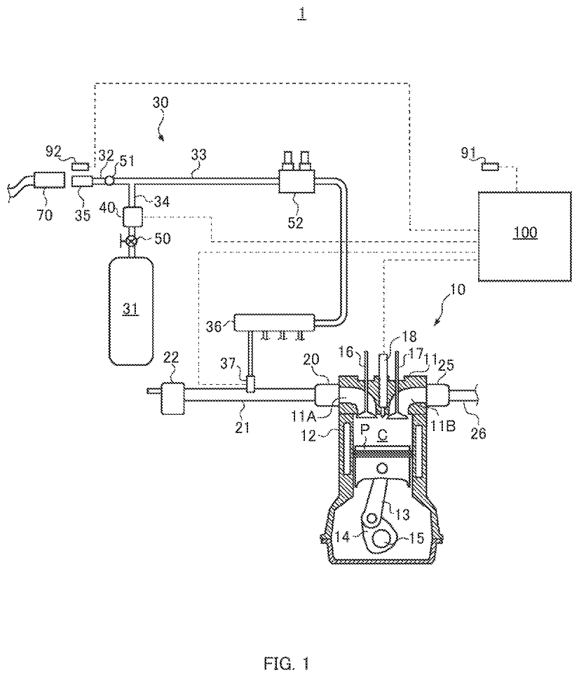

FIG. 1 is a schematic overall configuration diagram showing an engine 10 and a gas fuel filling and supplying system 30 according to the present embodiment.

As shown in FIG. 1, the engine 10, serving as a drive power source, is mounted on a vehicle 1. The engine 10 is a gas engine using gas as a fuel, and is configured as a CNG engine using CNG as the fuel in the present embodiment.

The engine 10 mainly includes a cylinder head 11 and an engine body including a cylinder block 12. The cylinder block 12 is provided with a cylinder C that reciprocally accommodates a piston P. A crankshaft 15 is connected to the piston P via a connecting rod 13, a crank arm 14, and the like, and reciprocating motion of the piston P is converted into rotational motion and transmitted to the crankshaft 15. For the sake of illustration, FIG. 1 shows only one cylinder among a plurality of cylinders of the engine 10, and the other cylinders are not shown. The engine 10 may be either multi-cylinder or single-cylinder.

The cylinder head 11 is provided with an intake port 11A and an exhaust port 11B. The intake port 11A is a part that introduces intake air into the cylinder C. The exhaust port 11B is a part through which exhaust is led out from the cylinder C. The cylinder head 11 is provided with an intake valve 16 and an exhaust valve 17. The intake valve 16 and the exhaust valve 17 are opened and closed by a valve mechanism (not shown). Further, the cylinder head 11 is provided with a spark plug 18. The spark plug 18 is a component that ignites CNG supplied to a combustion chamber of the cylinder C.

An intake manifold 20 is provided at a side portion of the cylinder head 11 on the intake side. The intake manifold 20 communicates with the intake port 11A. An intake passage 21 is connected to the intake manifold 20. The intake passage 21 is for introducing intake air. In the intake passage 21, an air cleaner 22, an injector 37, and the like are provided in this order from upstream of intake. The air cleaner 22 is a device that removes foreign substances. The injector 37 is a device that injects CNG. In the figure, a reference numeral 25 denotes an exhaust manifold that collects exhaust gas, and a reference numeral 26 denotes an exhaust passage for leading exhaust out from the exhaust manifold 25.

The gas fuel filling and supplying system 30 includes a fuel tank 31, a filling pipe 32, a supplying pipe 33, and a branch pipe 34. The fuel tank 31 is a tank that stores CNG. The filling pipe 32 is a pipe for filling CNG. The supplying pipe 33 is a pipe for supplying CNG.

A filling port 35 is provided at an upstream end of the filling pipe 32. The filling port 35 is an approximately cylindrical part into which a fuel nozzle 70 is inserted when the CNG is filled. A downstream end of the filling pipe 32 joins the upstream end of the supplying pipe 33. The downstream end of the supplying pipe 33 is connected to a fuel gallery 36, and CNG is distributed and supplied to the injector 37 of each cylinder via the fuel gallery 36.

The branch pipe 34 branches from a connecting site between the filling pipe 32 and the supplying pipe 33, and is connected to the fuel tank 31. The branch pipe 34 is provided with a manual valve 50 and a solenoid valve 40 serving as a main stop valve. The solenoid valve 40 is a normally closed solenoid valve, and opens when a current flows through an electromagnetic coil (not shown) in response to a command from the controller 100. The solenoid valve 40 is opened (ON) while the engine 10 is driven, and causes CNG to flow from the fuel tank 31 to the supplying pipe 33. Further, the solenoid valve 40 is closed (OFF) while the engine 10 is stopped, and prevents leakage of CNG from the fuel tank 31. A detailed configuration of the solenoid valve 40 will be described later.

The filling pipe 32 is provided with a check valve 51. The check valve 51 prevents the CNG from flowing back from the fuel tank 31 to the filling port 35. The supplying pipe 33 is provided with a regulator 52. The regulator 52 is a device for decompressing or regulating the pressure of high-pressure CNG supplied from the fuel tank 31.

An engine switch 91 and a nozzle sensor 92 are electrically connected to the controller 100. The engine switch 91 transmits, to the controller 100, an ON/OFF signal indicating whether the engine 10 is running or stopped. The nozzle sensor 92 (detection means of the present disclosure) detects insertion of the fuel nozzle 70 into the filling port 35 and removal of the fuel nozzle 70 from the filling port 35. Here, the nozzle sensor 92 is provided adjacent to the filling port 35, and detects insertion or removal of the fuel nozzle 70 by contacting the fuel nozzle 70. The nozzle sensor 92 is not limited to a contact type sensor, and may be a non-contact type sensor.

### [Solenoid Valve]

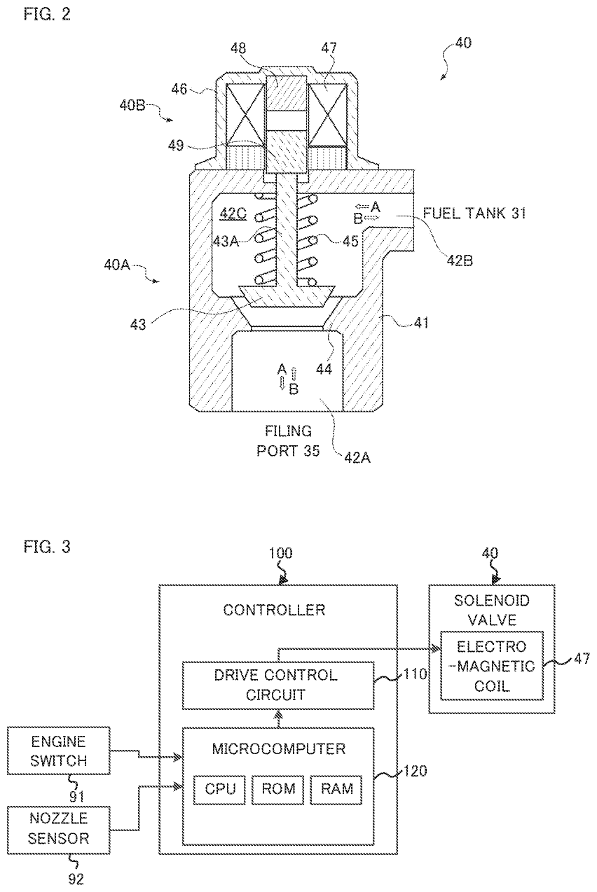

FIG. 2 is a schematic cross-sectional view showing the solenoid valve 40 according to the present embodiment.

As shown in FIG. 2, the solenoid valve 40 includes a valve part 40A and a solenoid part 40B. The valve part 40A includes a housing 41 interposed in the branch pipe 34 (see FIG. 1). The housing 41 is provided with a first flow passage 42A, a second flow passage 42B, and a chamber 42C. The first flow passage 42A communicates with the filling port 3 side. The second flow passage 42B communicates with the fuel tank 31 side. The chamber 42C communicates with the first flow passage 42A and the second flow passage 42B. In the chamber 42C, a valve element 43 is accommodated such that it can move in an axial direction.

The second flow passage 42B is connected to the chamber 42C from a direction approximately orthogonal to the axial direction of the valve element 43. The first flow passage 42A is connected to the chamber 42C from the axial direction of the valve element 43. A valve seat 44 is provided between the first flow passage 42A and the chamber 42C. The valve seat 44 is a part on which the valve element 43 is seated. The chamber 42C is provided with a spring 45. The spring 45 is a part that constantly urges the valve element 43 toward the valve seat 44 to seat the valve element 43 on the valve seat 44.

The solenoid part 40B includes a case 46. The case 46 is a bottomed cylindrical part attached to the housing 41. An electromagnetic coil 47 is accommodated in the case 46, and a fixed iron core (plug nut) 48 and a movable iron core (plunger) 49 are provided in the electromagnetic coil 47. The fixed iron core 48 is fixed in the electromagnetic coil 47 so as not to move in the axial direction. The movable iron core 49 is provided such that it can move in the axial direction and coaxially with the fixed iron core 48. A rod 43A of the valve element 43 is fixed to the movable iron core 49 such that they can move integrally. The material of the fixed iron core 48 and the movable iron core 49 is not limited to iron, and a wide range of magnetic materials other than iron can be used.

The solenoid valve 40 supplies a current to the electromagnetic coil 47 when the engine 10 is driven. When the electromagnetic coil 47 is energized, the fixed iron core 48 is magnetized by magnetic force, and the movable iron core 49 is attracted to the fixed iron core 48 side by the magnetic force, whereby the valve element 43 is separated from the valve seat 44 against a biasing force of the spring 45. When the valve element 43 is separated from the valve seat 44, the solenoid valve 40 enters an open state in which the CNG flows from the second flow passage 42B toward the first flow passage 42A in the direction of an arrow A.

On the other hand, the solenoid valve 40 interrupts the supply of current to the electromagnetic coil 47 when the engine 10 is stopped. When the electromagnetic coil 47 is de-energized, the valve element 43 is pressed against the valve seat 44 by the biasing force of the spring 45, whereby the solenoid valve 40 enters a closed state in which the flow of the CNG in the direction of the arrow A from the second flow passage 42B toward the first flow passage 42A is interrupted.

Here, even when the CNG is filled, the CNG in the direction of an arrow B filled from the first flow passage 42A side pushes open the valve element 43 and flows to the second flow passage 42B when the solenoid valve 40 is in the closed state. At this time, since the CNG pushes open the valve element 43 against the biasing force of the spring 45, the CNG may vibrate the valve element 43 in the axial direction (vertical direction in the figure) depending on velocity, pressure, specific gravity, and the like of flowing fluid. The solenoid valve 40 of the present embodiment has a function of suppressing the occurrence of such vibration at the time of filling the CNG. Hereinafter, details of this function will be described.

### [Controller]

FIG. 3 is a schematic diagram showing the controller 100 according to the present embodiment and related peripheral configurations.

The controller 100 is a device, such as a computer, that performs computation, and includes a drive control circuit 110 and a microcomputer (hereinafter referred to as a microcomputer) 120, for example.

The drive control circuit 110 is an IC, and controls energization of the electromagnetic coil 47 of the solenoid valve 40, for example. The microcomputer 120 includes a CPU, a ROM, a RAM, and the like. An ON/OFF signal indicating whether the engine 10 is running or stopped is input to the microcomputer 120 from the engine switch 91. A detection signal indicating insertion of the fuel nozzle 70 into the filling port 35 and a detection signal indicating removal of the fuel nozzle 70 from the filling port 35 are input to the microcomputer 120 from the nozzle sensor 92.

When the engine switch 91 is turned on, the drive control circuit 110 supplies a current to the electromagnetic coil 47 from an in-vehicle battery (not shown) to energize the electromagnetic coil 47. When the electromagnetic coil 47 is energized, the solenoid valve 40 enters an open state in which the CNG flows.

On the other hand, when the engine switch 91 is turned OFF, the drive control circuit 110 cuts off the current to the electromagnetic coil 47, thereby de-energizing the electromagnetic coil 47. When the electromagnetic coil 47 is de-energized, the solenoid valve 40 enters a closed state in which outflow of the CNG from the fuel tank 31 is interrupted.

When the nozzle sensor 92 detects the insertion of the fuel nozzle 70 while the engine switch 91 is in the OFF state, the drive control circuit 110 supplies a current to the electromagnetic coil 47 from an in-vehicle battery (not shown), thereby controlling the solenoid valve 40 to be in the open state. As a result, when the CNG passes through the solenoid valve 40, the CNG smoothly flows through the solenoid valve 40 in the open state without pushing open the valve element 43, thereby reliably preventing the occurrence of vibration at the time of filling. When the nozzle sensor 92 detects the removal of the fuel nozzle 70 that accompanies the completion of filling the CNG, the drive control circuit 110 switches the solenoid valve 40 from the open state to the closed state by de-energizing the electromagnetic coil 47.

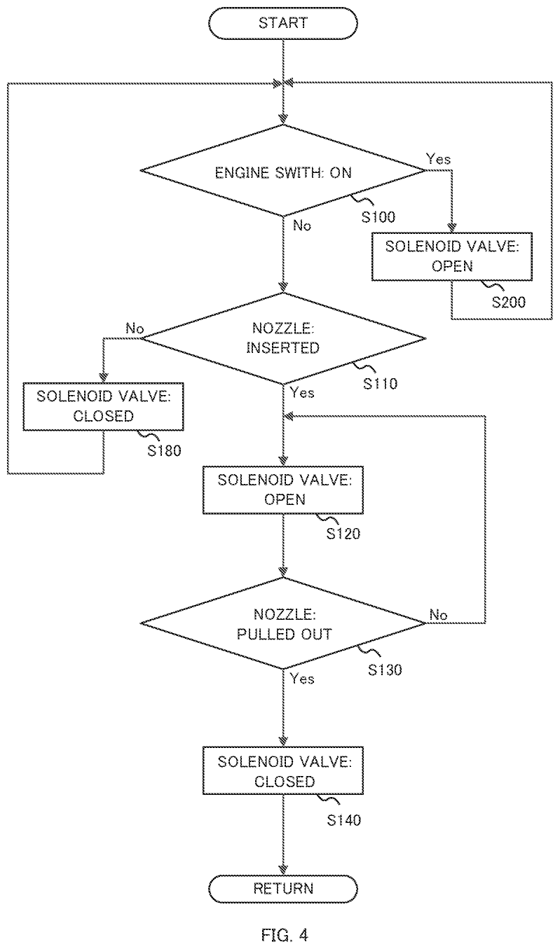

Next, a control process according to the present embodiment will be described with reference to FIG. 4.

In step S100, it is determined whether the engine switch 91 is turned on. If the engine switch 91 is turned on (Yes in S100), this control process proceeds to processing of step S200. On the other hand, if the engine switch 91 is not turned on (NO in S100), that is, if the engine switch 91 is turned off, this control process proceeds to a determination process of step S110.

In step S200, the electromagnetic coil 47 is energized and the solenoid valve 40 enters an open state. Once the solenoid valve 40 is opened, this control process returns to the determination of step S100.

In step S110, it is determined whether the fuel nozzle 70 has been inserted into the filling port 35. If the fuel nozzle 70 is inserted into the filling port 35 (Yes in S110), this control process proceeds to processing of step S120. On the other hand, if the fuel nozzle 70 is not inserted into the filling port 35 (No in S110), this control process proceeds to processing of step S180, in which the solenoid valve 40 is maintained to be in the closed state, and returns to the determination of step S100.

In step S120, the electromagnetic coil 47 is energized to open the solenoid valve 40. Next, in step S130, it is determined whether the fuel nozzle 70 has been pulled out from the filling port 35. If the fuel nozzle 70 is not pulled out from the filling port 35 (No in S130), this control process returns to processing of step S120. On the other hand, if the fuel nozzle 70 is pulled out from the filling port 35 (Yes in S130), this control process proceeds to processing of step S140, in which the solenoid valve 40 enters a closed state by de-energizing the electromagnetic coil 47, and then proceeds to return.

According to the present embodiment described in detail above, the present disclosure includes the solenoid valve 40, serving as the main stop valve, which is provided in the branch pipe 34 which branches from the connecting site between the filling pipe 32 and the supplying pipe 33 and is connected to the fuel tank 31. The present embodiment is configured to control the solenoid valve 40 to enter the open state when filling the fuel tank 31 with the CNG from the filling port 35 through the filling pipe 32 and the branch pipe 34.

Accordingly, when the CNG is filled, the CNG smoothly flows through the solenoid valve 40 without pushing open the valve element 43 of the solenoid valve 40, and vibration of the valve element 43 in the axial direction can be effectively prevented. Further, since the vibration of the valve element 43 is suppressed, it is possible to effectively prevent noise and a reduction of durability of the branch pipe 34 caused by the vibration.

When the CNG is filled, the solenoid valve 40 is opened at the same time that the fuel nozzle 70 is inserted into the filling port 35 and closed at the same time that the fuel nozzle 70 is pulled out from the filling port 35. This makes it possible to more effectively prevent leakage of the CNG from the fuel tank 31 as compared with the case where opening and closing of the solenoid valve 40 is controlled in accordance with opening and closing of a door covering the filling port 35.

### [Others]

The present disclosure is not limited to the above-described embodiments, and can be appropriately modified and implemented without departing from the gist of the present disclosure.

For example, the solenoid valve 40 has been described as being applied to the filling and supplying system of CNG in the above embodiment, but the solenoid valve 40 may be applied to a filling and suppling system of other fluids (including liquids and gases). Further, the application of the present disclosure is not limited to the gas engine mounted on the vehicle 1, and can be widely applied to a gas engine of an industrial machine such as a generator.

### DESCRIPTION OF SYMBOLS

10 . . . Engine, 21 . . . Intake passage, 30 . . . Gas fuel filling and supplying system, 31 . . . Fuel tank (tank), 32 . . . Filling pipe, 33 . . . Supplying pipe, 34 . . . Branch pipe, 35 . . . Filling port, 37 . . . Injector, 40 . . . Solenoid valve, 40A . . . Valve part, 40B . . . Solenoid part, 41 . . . Housing, 42A . . . First flow passage, 42B . . . Second flow passage, 42C . . . Chamber, 43 . . . Valve element, 44 . . . Valve seat, 45 . . . Spring, 46 . . . Case, 47 . . . Electromagnetic coil, 48 . . . Fixed iron core, 49 . . . Movable iron core, 70 . . . Fuel nozzle, 91 . . . Engine switch, 92 . . . Nozzle sensor (detection means), 100 . . . Controller (control part), 110 . . . Drive control circuit, 120 . . . Microcomputer

1. A gas fuel filling and supplying system comprising:
a tank that stores gas fuel;
a filling pipe provided with a filling port for the gas fuel at an upstream end;
a supplying pipe having an upstream end connected to a downstream end of the filling pipe and a downstream end connected to an injector facing an intake passage of a gas engine;
a branch pipe that branches from a connection part between the filling pipe and the supplying pipe and is connected to the tank;
a normally closed solenoid valve provided in the branch pipe; and
a control part that controls opening and closing of the solenoid valve, wherein the control part controls the solenoid valve to be in an open state while the gas engine is driven, controls the solenoid valve to be in a closed state while the gas engine is stopped, and controls the solenoid valve to be in an open state during filling of the tank with the gas fuel from the filling port.

2. The gas fuel filling and supplying system according to claim 1, further comprising:
a detection means that detects insertion of the fuel nozzle into the filling port and removal of the fuel nozzle from the filling port, wherein
the control part controls the solenoid valve to be in an open state when the detection means detects the insertion of the fuel nozzle, and controls the solenoid valve to be in a closed state when the detection means detects the removal of the fuel nozzle.

3. The gas fuel filling and supplying system according to claim 2, further comprising:
an engine switch that transmits a signal indicating running or stoppage of the gas engine to the control part; and
a battery, wherein
the solenoid valve includes an electromagnetic coil, and
the control part controls the solenoid valve to be in an open state by supplying a current from the battery to the electromagnetic coil when the detection means detects the insertion of the fuel nozzle while receiving a signal indicating stoppage of the gas engine from the engine switch.

4. The gas fuel filling and supplying system according to claim 3, wherein the control part determines whether the detection means has detected the removal of the fuel nozzle while controlling the electromagnetic coil to be energized and the solenoid valve to be in the open state due to the detection means detecting the insertion of the fuel nozzle.

5. The gas fuel filling and supplying system according to claim 4, wherein the detection means detects insertion of the fuel nozzle to the filling port or removal of the fuel nozzle from the filling port by contacting the fuel nozzle.
